(19) United States
(12) Patent Application Publication
(10) Pub. No.: US 2022/0266191 A1
(43) Pub. Date: Aug. 25, 2022

(54) Dehumidification Bag Capable of Being Placed in Multiple Formse

(71) Applicant: Zhuhai Hermesin Enterprises CO.,LTD, Zhuhai (CN)

(72) Inventors: Xi Lu, Zhuhai (BG); Tai Xing Yin, Zhuhai (CN)

(21) Appl. No.: 17/182,287

(22) Filed: Feb. 23, 2021

(51) Int. Cl. B01D 53/04; B01D 53/26

(52) U.S. Cl. CPC B01D 53/0407; B01D 53/261; B01D 2257/80; B01D 2259/4525

(57) ABSTRACT

The present invention discloses a dehumidification bag capable of being placed in multiple forms, having a bag body and a moisture absorbing medium placed in the bag body, wherein the surface of the bag body is provided with a gas permeable zone, the rest is a sealing zone except for the gas permeable zone, and the moisture absorbing medium absorbs moisture in air through the gas permeable zone; and the bottom of the bag body is provided with an expanding portion that allows the bag body to be placed upright. The present invention has the following beneficial technical effects: the present invention is simple in structure and convenient to use; the present invention not only reduces the use of space, but also maximizes the applicable range; secondly, since the present invention is suitable for different placement postures, it can be placed freely on the premise of ensuring that the gas permeable zone is not blocked; thirdly, the present invention minimizes the impact on the environment and has a beneficial environment-friendly effect; and finally, the sealing zone is printable with patterns or is provided with shapes such that the friendliness to end consumers is greatly improved and the product is no longer monotonous, and the bag body can be of any shape to meet the needs of different consumers.

### TECHNICAL FIELD

The present invention relates to the technical field of dehumidification, and in particular to a dehumidification bag capable of being placed in multiple forms.

### BACKGROUND ART

In humid areas, wardrobes, drawers, shoe cabinets, bookcases, storage boxes, musical instruments, calligraphy and paintings, other valuables, etc. are prone to moisture, and thus there is a phenomenon of dampness and mildew.

At present, the dehumidification box is generally sold in the market, which brings a lot of convenience to the user, and also prolongs the service life of many household items. The dehumidification box in the market mainly uses flaky, powdery or granular calcium chloride for dehumidification, which can play a certain dehumidification effect, but also has the following defects:

1, the dehumidification box is of a hard plastic structure and occupies a certain space for use;

2, the dehumidification box will store excess moisture into it, and if the dehumidification box is in an improper position or receives an external force, it will easily cause the absorbed moisture to flow out;

3, it is necessary to periodically drain the water from the dehumidification box;

4, the dehumidification bag is placed in a single way and is limited in use;

5, at present, the dehumidification box is basically on the market, but such a dehumidification box is also a disposable item, and is discarded after use, resulting in plastic waste, affecting the environment, and being not conducive to environmental protection; and

6, the dehumidification box is easy to break, which is not easy to detect, and is easy to fall.

### SUMMARY OF THE INVENTION

In view of the deficiencies of the existing technologies in the market, the present invention aims to provide a dehumidification bag capable of being placed in multiple forms. By placing the moisture absorbing medium in the gas permeable zone in the bag body, the bag body can be configured to adapt to different placement postures, and is suitable for different application scenarios. Besides, the bag body is also provided with a sealing zone in which different patterns can be printed or different shapes can be manufactured, thereby solving the problem of monotonous shape of the existing dehumidification bag, and enhancing the friendliness of the present invention to the consumer. Finally, the bag body can also be manufactured in different shapes to meet the needs of the market.

In order to achieve the above objective, the present invention adopts the following technical solutions:

A dehumidification bag capable of being placed in multiple forms has a bag body and a moisture absorbing medium placed in the bag body, wherein the surface of the bag body is provided with a gas permeable zone, the rest is a sealing zone except for the gas permeable zone, and the moisture absorbing medium absorbs moisture in air through the gas permeable zone.

It should be further noted that in order to achieve the upright placement of the bag body, the bottom of the bag body is provided with an expanding portion, which can increase the area of the bottom of the bag body to achieve uprightness.

It should be further noted that the expanding portion and the bag body may be of a separate structure, and the expanding portion is heat-sealed with the periphery of the bottom of the bag body so as to be connected to the bag body.

It should be further noted that the gas permeable zone is covered with a gas permeable material.

It should be further noted that the gas permeable material may be a material that achieves this function in the prior art, such as a gas permeable film or the like.

Further, the area of the gas permeable zone and the number of gas permeable zones may be set according to actual needs, for example, the area of the gas permeable zone may be part or all of the sealing zone; at least 1 gas permeable zone is provided, or 2 or more gas permeable zones can be disposed in a matrix form or disposed regularly or irregularly.

As a preferred technical solution, the top of the bag body is provided with an openable and closable sealing strip.

As another preferred technical solution, the top of the bag body is provided with a perforation for hanging the bag body.

It should be further noted that the perforation is disposed at one side or the middle of the top of the bag body.

As still another preferred technical solution, the top of the bag body is provided with a hanger for hanging.

As still another preferred technical solution, the top of the bag body is provided with a hanging rope for hanging.

As still another preferred technical solution, a protective layer is also provided, the protective layer being disposed on the surface of the gas permeable material.

As still another preferred technical solution, the protective layer is heat-sealed to the surface of the gas permeable material; and the periphery of the protective layer is stuck to the sealing zone of the periphery of the gas permeable material, thereby reducing damage to the gas permeable material when tearing.

Furthermore, the protective layer can be disposed according to the area of the gas permeable zone by sticking or heat sealing; for example, when a portion of the sealing zone is a gas permeable zone, the protective layer can be disposed by sticking; and when the gas permeable zone is the entire area of the sealing zone on one side, that is, the edge of the gas permeable zone overlaps with the edge of the sealing zone on one side or two side edges of the gas permeable zone overlap with a portion of side edge of the sealing zone on one side, the protective layer can be disposed by heat sealing.

As a preferred technical solution, the sealing zone is printable with different patterns or shapes. Further, the shape is protrusible from the bag body.

As still another preferred technical solution, a window may be disposed on the surface of the sealing zone of the bag body. Further, the window is provided with a transparent card, and one side of the window is provided with a water level scale line.

The present invention has the following beneficial technical effects: the present invention is simple in structure and convenient to use; the present invention not only reduces the use of space, but also maximizes the applicable range; secondly, since the present invention is suitable for different placement postures, it can be placed freely on the premise of ensuring that the gas permeable zone is not blocked; thirdly, the present invention minimizes the impact on the environment and has a beneficial environment-friendly effect; and finally, the sealing zone is printable with patterns or is provided with shapes such that the friendliness to the end consumers is greatly improved and the product is no longer monotonous, and the bag body can be of any shape to meet the needs of different consumers.

### BRIEF DESCRIPTION OF THE DRAWINGS

FIG. 1 is a structure schematic view of the present invention;

FIG. 2 is a cross-sectional structure schematic view of the present invention;

FIG. 3 is a structure schematic view of another implementation of the present invention;

FIG. 4 is a structure schematic view of another implementation of the present invention;

FIG. 5 is a structure schematic view of another implementation of FIG. 4;

FIG. 6 is a structure schematic view of another implementation of the present invention;

FIG. 7 is a structure schematic view of another implementation of the present invention;

FIG. 8 is a structure schematic view of another implementation of the present invention;

FIG. 9 is a schematic view of a gas permeable zone in a different shape according to the present invention; and

FIG. 10 is a schematic view of another gas permeable zone in a different shape according to the present invention.

### DETAILED DESCRIPTION OF THE INVENTION

The present invention will be further described with reference to the accompanying drawings. It should be noted that the following embodiment gives detailed implementations and specific operation procedures on the premise of this technical solution, but the protection scope of the present invention is not limited to this embodiment.

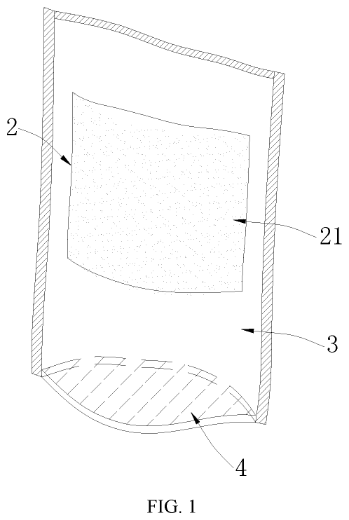

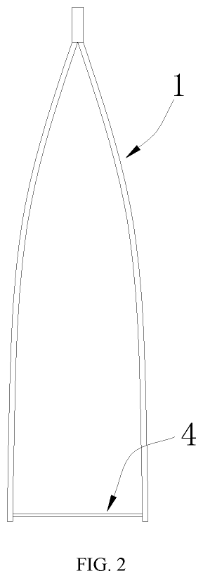

As shown in FIG. 1 and FIG. 2, the present invention relates to a dehumidification bag capable of being placed in multiple forms, having a bag body 1 and a moisture absorbing medium placed in the bag body 1. The surface of the bag body 1 is provided with a gas permeable zone 2, the rest is a sealing zone 3 except for the gas permeable zone 2, and the moisture absorbing medium absorbs moisture in air through the gas permeable zone 2.

The preferred embodiment is provided below to better illustrate the structure of the present invention, but this embodiment is only for the purpose of the present invention and is not intended to limit the structure of the present invention.

Preferably, the sealing zone of the present invention includes a first sealing zone and a second sealing zone, and the edges of the first sealing zone and the second sealing zone are heat-sealed to form a bag body; and the gas permeable zone may be disposed on the first sealing zone and/or the second sealing zone.

It should be further noted that, as shown in FIG. 1 and FIG. 2, in order to achieve the upright placement of the bag body, the bottom of the bag body is provided with an expanding portion 4. Furthermore, the expanding portion and the bag body may be of a separate structure, and the expanding portion is heat-sealed with the periphery of the bottom of the first sealing zone and the second sealing zone so as to be connected to the bag body.

Furthermore, the shape of the bag body includes, but is not limited to, existing geometric figures, such as a circular shape, an elliptical shape, a cylindrical shape, and the like, and may also be formed into a special shape.

As shown in FIG. 1, the gas permeable zone 2 is covered with a gas permeable material 21.

It should be further noted that the gas permeable material may be a material that achieves this function in the prior art, such as a gas permeable film or the like.

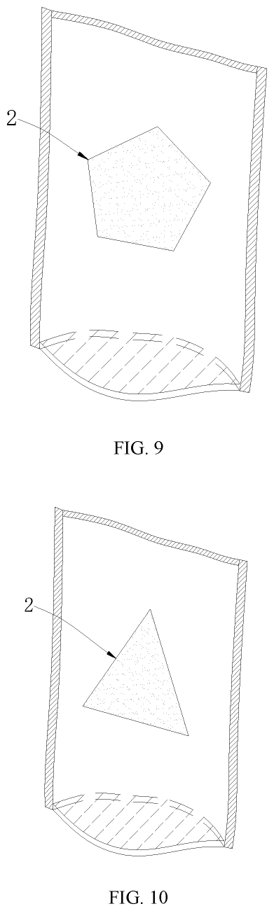

Further, the area of the gas permeable zone and the number of gas permeable zones may be set according to actual needs, for example, the area of the gas permeable zone may be part or all of the first sealing zone or second sealing zone; at least 1 gas permeable zone is provided, or 2 or more gas permeable zones can be disposed in a matrix form or disposed regularly or irregularly. Furthermore, the shape of the gas permeable zone includes, but is not limited to, existing geometric figures, and may also be formed into a special shape, as shown in FIG. 9 and FIG. 10.

Further, the first sealing zone or the second sealing zone may be made of a transparent or opaque waterproof material, such as a transparent material, so that the moisture absorption degree of the moisture absorbing medium can be more intuitively observed.

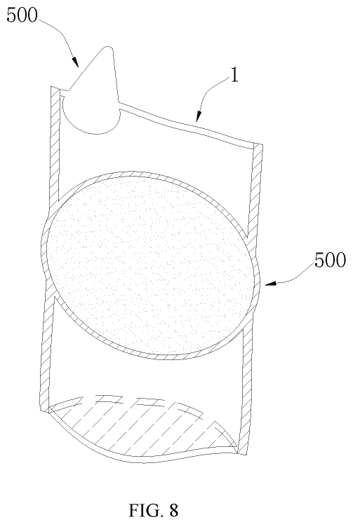

Further, as shown in FIG. 8, if an opaque material is used, different patterns may be printed on the surface thereof, or the first sealing zone and/or the second sealing zone may be set to have a certain shape; and furthermore, the shape 500 is protrusible from the bag body 1.

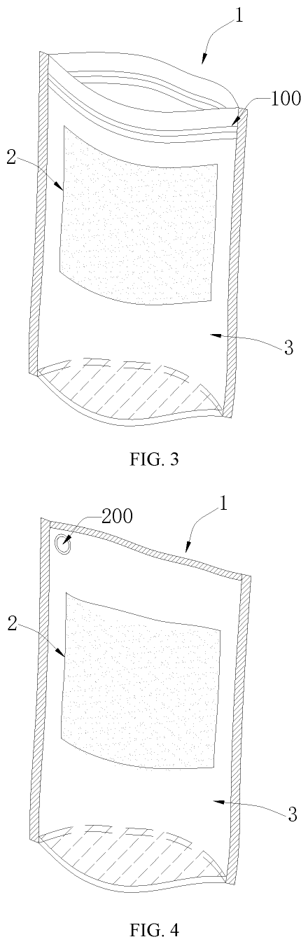

As shown in FIG. 3, as an implementation, the surface of the bag body 1 is provided with a gas permeable zone 2, the rest is a sealing zone 3 except for the gas permeable zone 2, and the moisture absorbing medium absorbs humid air through the gas permeable zone 2. Further, the top of the bag body 1 is provided with an openable and closable sealing strip 100.

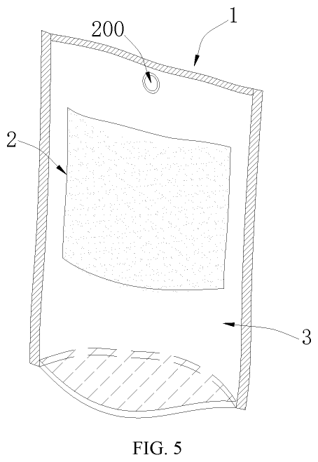

As shown in FIG. 4 and FIG. 5, as another implementation, the surface of the bag body 1 is provided with a gas permeable zone 2, the rest is a sealing zone 3 except for the gas permeable zone 2, and the moisture absorbing medium absorbs humid air through the gas permeable zone 2. Further, the top of the bag body 1 is provided with a perforation 200 for hanging the bag body. Furthermore, the perforation 200 may be disposed at one side or the middle of the top of the bag body 1.

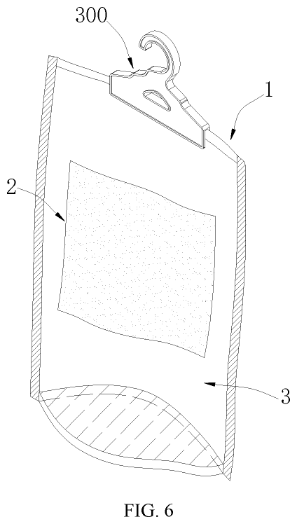

As shown in FIG. 6, as another implementation, the bag body 1 is provided with a gas permeable zone 2 and a sealing zone 3 (3 is not marked), and the moisture absorbing medium absorbs humid air through the gas permeable zone 2. Further, the top of the bag body 1 is provided with a hanger 300.

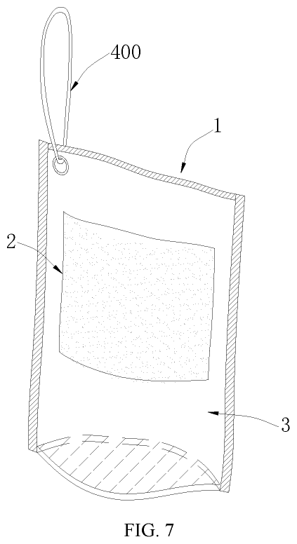

As shown in FIG. 7, as another implementation, the bag body 1 is provided with a gas permeable zone 2 and a sealing zone 3, and the moisture absorbing medium absorbs humid air through the gas permeable zone 2. Further, as still another preferred technical solution, the top of the bag body 1 is provided with a hanging rope 400 for hanging.

Furthermore, the expanding portion functions to allow the bag body to be placed upright. At the same time, when the present invention is provided with the expanding portion, a sealing strip, a hanger or a perforation can also be disposed on the top of the bag body, so that different placement modes can be simultaneously provided.

As a preferred technical solution, the first sealing zone or the second sealing zone is printable with different patterns or shapes.

It should be further noted that, as another preferred technical solution, the present invention is further provided with a protective layer, the protective layer being disposed on the surface of the gas permeable material.

In order to reduce the influence of the protective layer on the gas permeable material, the protective layer may be disposed by heat sealing or sticking. In particular, when the heat sealing is adopted, the protective layer is heat-sealed to the surface of the gas permeable material; and when the sticking is adopted, the periphery of the protective layer is stuck to the first sealing zone and/or the second sealing zone of the periphery of the gas permeable material, thereby reducing damage to the gas permeable material when tearing the protective layer.

Furthermore, the protective layer can be disposed according to the area of the gas permeable zone by sticking or heat sealing; for example, when a portion of the sealing zone is a gas permeable zone, the protective layer can be disposed by sticking; and when the gas permeable zone is the entire area of the first sealing zone and/or the second sealing zone, that is, the edge of the gas permeable zone overlaps with the edge of the first sealing zone and/or the second sealing zone or two side edges of the gas permeable zone overlap with a portion of side edge of the first sealing zone and/or the second sealing zone, the protective layer can be disposed by heat sealing.

Further, the protective layer may be made of a film or sheet having hardness, which can provide a partial manufacturing effect to the bag body of the present invention in an upright state. Certainly, the sealing zone of the bag body can be made of a hard material to ensure the upright posture of the bag body.

As still another preferred technical solution, when a portion of the first sealing zone or the second sealing zone of the bag body is made of a transparent material, the water level scale line may be disposed on one side of the transparent material. Thus, when the moisture absorbing medium is calcium chloride, the water level change in the bag can be observed through the transparent material to determine the moisture absorption amount.

It should be further noted that the gas permeable material in the present invention may be a material that achieves this function in the prior art, such as a gas permeable film or the like.

In addition to the dehumidification function described in the present invention, similarly, a medium having an insect-proof function or a medium having an aromatic function can be directly added to the bag body to further realize various purposes of the present invention.

When the above-mentioned moisture absorbing medium is added with an insect-proof medium, the structure of the present invention can be changed according to actual conditions.

### Embodiment

When in use, the present invention can be placed in a position in need of absorbing moisture by hanging, standing upright or lying down, and then absorbs moisture through the gas permeable zone disposed on the bag body. Specifically, the side provided with the gas permeable material is used for moisture absorption. When a material that is discolored by moisture is adopted as the moisture absorbing medium, the moisture absorption degree of the present invention can be known by the color change, and thereby whether the moisture absorbing medium needs to be replaced can be determined. In addition, when the moisture absorbing medium is calcium chloride, the water level change in the bag can be observed through the window on the bag body, and the water level can be determined by the water level line.

Secondly, the surface of the gas permeable material of the present invention is further provided with a protective layer. The protective layer is disposed by heat sealing on the surface of the gas permeable material or by sticking to the sealing zone of the periphery of the surface of the gas permeable material, and the present invention can be used after the protective layer is torn off.

Thirdly, the sealing zone of the present invention can be made of a transparent or opaque waterproof material, but whether it is made of a transparent or opaque material, the pattern can be printed on the surface, or the shape can be designed to improve the friendliness of the product, as shown in FIG. 8.

Fourthly, different media can be placed in the bag body of the present invention to achieve different purposes. If an insect-proof medium is placed, it can prevent insects; and if a volatile aromatic medium is placed, the fragrance in the environment can be increased.

Finally, the bag body of the present invention can be formed in different shapes, including, but not limited to, existing conventional geometric solid figures and the like.

A person skilled in the art can make various corresponding changes and modifications according to the above technical solutions and concepts, and all such changes and modifications should be included in the protection scope of the claims of the present invention.

1. A dehumidification bag capable of being placed in multiple forms, having a bag body and a moisture absorbing medium placed in the bag body, wherein the surface of the bag body is provided with a gas permeable zone, the rest is a sealing zone except for the gas permeable zone, and the moisture absorbing medium absorbs moisture in air through the gas permeable zone; and the bottom of the bag body is provided with an expanding portion.

2. The dehumidification bag capable of being placed in multiple forms according to claim 1, wherein the gas permeable zone is covered with a gas permeable material.

3. The dehumidification bag capable of being placed in multiple forms according to claim 1, wherein the top of the bag body is provided with an openable and closable sealing strip.

4. The dehumidification bag capable of being placed in multiple forms according to claim 1, wherein the top of the bag body is provided with a perforation for hanging the bag body.

5. The dehumidification bag capable of being placed in multiple forms according to claim 1, wherein the perforation is disposed at one side or the middle of the top of the bag body.

6. The dehumidification bag capable of being placed in multiple forms according to claim 1, wherein the top of the bag body is provided with a hanger.

7. The dehumidification bag capable of being placed in multiple forms according to claim 1, wherein the top of the bag body is provided with a hanging rope.

8. The dehumidification bag capable of being placed in multiple forms according to claim 1, wherein the sealing zone is printable with different patterns or shapes; and the shape is protrusible from the bag body.

9. The dehumidification bag capable of being placed in multiple forms according to claim 1 or 2, wherein a protective layer is also provided, the protective layer being disposed on the surface of the gas permeable zone.

10. The dehumidification bag capable of being placed in multiple forms according to claim 9, wherein the protective layer is heat-sealed to the surface of the gas permeable zone; and the periphery of the protective layer is stuck to the sealing zone of the periphery of the gas permeable material.
